(19) United States
(12) Patent Application Publication
(10) Pub. No.: US 2018/0349746 A1
(43) Pub. Date: Dec. 6, 2018

(54) Top-View Lidar-Based Object Detection

(71) Applicant: Uber Technologies, Inc., San Francisco, CA (US)

(72) Inventor: Carlos Vallespi-Gonzalez, Pittsburgh, PA (US)

(21) Appl. No.: 15/609,141

(22) Filed: May 31, 2017

(51) Int. Cl. G06K 9/62; G01S 7/48; G01S 17/93; G01S 17/89; G06K 9/00; G05D 1/02

(52) U.S. Cl. CPC G06K 9/6277; G01S 7/4808; G01S 17/936; G05D 1/024; G06K 9/6218; G06K 9/6282; G06K 9/00791; G01S 17/89

(57) ABSTRACT

Systems and methods for detecting and classifying objects proximate to an autonomous vehicle can include a sensor system and a vehicle computing system. The sensor system includes at least one LIDAR system configured to transmit ranging signals relative to the autonomous vehicle and to generate LIDAR data. The vehicle computing system receives LIDAR data from the sensor system and generates a top-view representation of the LIDAR data that is discretized into a grid of multiple cells, each cell representing a column in three-dimensional space. The vehicle computing system also determines one or more cell statistics characterizing the LIDAR data corresponding to each cell and/or a feature extraction vector for each cell by aggregating the one or more cell statistics of surrounding cells at one or more different scales. The vehicle computing system then determines a classification for each cell based at least in part on the feature extraction vectors.

### FIELD

The present disclosure relates generally to detecting objects of interest. More particularly, the present disclosure relates to detecting and classifying objects that are proximate to an autonomous vehicle using top-view LIDAR-based object detection.

### BACKGROUND

An autonomous vehicle is a vehicle that is capable of sensing its environment and navigating with little to no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path through such surrounding environment.

Thus, a key objective associated with an autonomous vehicle is the ability to perceive objects (e.g., vehicles, pedestrians, cyclists) that are proximate to the autonomous vehicle and, further, to determine classifications of such objects as well as their locations. The ability to accurately and precisely detect and characterize objects of interest is fundamental to enabling the autonomous vehicle to generate an appropriate motion plan through its surrounding environment.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for detecting objects of interest. The method includes receiving, by a computing system that comprises one or more computing devices, LIDAR data from one or more LIDAR systems configured to transmit ranging signals relative to an autonomous vehicle. The method also includes generating, by the computing system, a top-view representation of the LIDAR data that is discretized into a grid of multiple cells. The method also includes determining, by the computing system, one or more cell statistics characterizing the LIDAR data corresponding to each cell. The method also includes determining, by the computing system, a classification for each cell based at least in part on the one or more cell statistics.

Another example aspect of the present disclosure is directed to an object detection system. The object detection system includes a LIDAR system configured to transmit ranging signals relative to an autonomous vehicle and to generate LIDAR data. The object detection system also includes one or more processors. The object detection system also includes a classification model, wherein the classification model has been trained to classify cells of LIDAR data. The object detection system also includes at least one tangible, non-transitory computer readable medium that stores instructions that, when executed by the one or more processors, cause the one or more processors to perform operations. The operations include determining one or more cell statistics characterizing the LIDAR data corresponding to each cell. The operations include providing the one or more cell statistics as input to the classification model. The operations include receiving, as output of the classification model, a classification for each cell.

Another example aspect of the present disclosure is directed to an autonomous vehicle. The autonomous vehicle includes a sensor system and a vehicle computing system. The sensor system includes at least one LIDAR system configured to transmit ranging signals relative to the autonomous vehicle and to generate LIDAR data. The vehicle computing system includes one or more processors and at least one tangible, non-transitory computer readable medium that stores instructions that, when executed by the one or more processors, cause the one or more processors to perform operations. The operations include receiving LIDAR data from the sensor system. The operations further include generating a top-view representation of the LIDAR data that is discretized into a grid of multiple cells, each cell representing a column in three-dimensional space. The operations further include determining one or more cell statistics characterizing the LIDAR data corresponding to each cell. The operations further include determining a feature extraction vector for each cell by aggregating the one or more cell statistics of surrounding cells at one or more different scales. The operations further include determining a classification for each cell based at least in part on the feature extraction vector for each cell.

Other aspects of the present disclosure are directed to various methods, systems, apparatuses, vehicles, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example top-view LIDAR-based object detection system according to example embodiments of the present disclosure;

FIG. 2 depicts a block diagram of an example system for controlling the navigation of a vehicle according to example embodiments of the present disclosure;

FIG. 3 depicts a block diagram of an example perception system according to example embodiments of the present disclosure;

FIG. 4 depicts an example top-view representation of LIDAR data according to example embodiments of the present disclosure;

FIG. 5 depicts an example top-view representation of LIDAR data discretized into cells according to example embodiments of the present disclosure;

FIG. 6 provides a visual example of how each cell in a top-view representation corresponds to a column in three-dimensional space according to example embodiments of the present disclosure;

FIG. 7 depicts an example representation of determining a feature extraction vector according to example embodiments of the present disclosure;

FIG. 8 depicts an example classification model according to example embodiments of the present disclosure;

FIG. 9 provides an example graphical depiction of classification determination according to example embodiments of the present disclosure;

FIG. 10 depicts example aspects associated with bounding shape generation according to example aspects of the present disclosure;

FIG. 11 provides a graphical depiction of example classification determinations and generated object segments according to example aspects of the present disclosure;

FIG. 12 provides a graphical depiction of detected object segments without utilizing top-view LIDAR-based object detection;

FIG. 13 provides a graphical depiction of detected object segments with utilizing top-view LIDAR-based object detection according to example aspects of the present disclosure;

FIG. 14 provides a block diagram of an example computing system according to example embodiments of the present disclosure;

FIG. 15 depicts a flowchart diagram of a first example method of top-view LIDAR-based object detection according to example embodiments of the present disclosure; and

FIG. 16 depicts a flowchart diagram of a second example method of top-view LIDAR-based object detection according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to detecting, classifying, and tracking objects, such as pedestrians, cyclists, other vehicles (whether stationary or moving), and the like, during the operation of an autonomous vehicle. In particular, in some embodiments of the present disclosure, an autonomous vehicle can include a computing system that detects objects of interest from within a top-view representation of LIDAR data obtained from one or more LIDAR systems. The LIDAR data can be received from one or more LIDAR systems configured to transmit ranging signals relative to an autonomous vehicle. A top-view representation of the LIDAR data can be generated as a discretized grid of multiple cells, each cell representing a column in three-dimensional space. One or more cell statistics can be determined for each cell and used in part to determine a classification for each cell indicating whether each cell includes a detected object of interest (e.g., a vehicle, a pedestrian, a bicycle, and/or no object). Cells having one or more predetermined classifications can be clustered together into one or more groups and optionally represented using bounding shapes to create object segments for relay to other autonomous vehicle applications including object classification and tracking. By using a top-down representation and analysis of LIDAR data, an object detection system according to embodiments of the present disclosure can more accurately detect, classify and track objects of interest. Object detection using a top-view representation of LIDAR data can be especially advantageous for detecting objects that are in close proximity to other objects, such as when a person is standing beside a vehicle. As a result of such improved object detection, classification, and tracking, further analysis in autonomous vehicle applications is enhanced, such as those involving prediction, motion planning, and vehicle control, leading to improved passenger safety and vehicle efficiency.

More particularly, in some embodiments of the present disclosure, an autonomous vehicle can include one or more sensor systems. Sensor systems can include one or more cameras and/or one or more ranging systems including, for example, one or more Light Detection and Ranging (LIDAR) systems, and/or one or more Range Detection and Ranging (RADAR) systems. In some implementations, the sensor system including the LIDAR system is mounted on the autonomous vehicle, such as, for example, on the roof of the autonomous vehicle. The one or more ranging systems can capture a variety of ranging data and provide it to a vehicle computing system, for example, for the detection, classification, and tracking of objects of interest during the operation of the autonomous vehicle. Additionally, in some embodiments, the object detection system can implement top-view LIDAR-based object detection. In particular, in some embodiments, top-view LIDAR-based object detection can include receiving LIDAR data from one or more LIDAR systems configured to transmit ranging signals relative to an autonomous vehicle. In some embodiments, LIDAR data includes a three-dimensional point cloud of LIDAR data points received from around the periphery of an autonomous vehicle.

According to a further aspect of the present disclosure, one or more computing devices associated with an autonomous vehicle can generate a top-view representation of the LIDAR data. A top-view representation can correspond, for example, to a two-dimensional representation of the LIDAR point cloud looking down from a birds-eye perspective. In some implementations, such top-view representation can be discretized into a grid of multiple cells. Each cell within the grid can correspond to a column in three-dimensional space.

More particularly, in some implementations, each cell in the grid of multiple cells can be generally rectangular such that each cell is characterized by a first dimension and a second dimension. In some implementations, although not required, the first dimension and second dimension of each cell is substantially equivalent corresponding to a grid of generally square-shaped cells. The first and second dimensions can be designed to create a suitable resolution based on the types of objects that are desired for detection. In some examples, each cell can be characterized by first and second dimensions on the order of between about 5 and 25 centimeters (cm). In some examples, each cell can be characterized by first and second dimensions on the order of about 10 cm. The LIDAR data can include a plurality of LIDAR data points that are projected onto respective cells within the grid of multiple cells.

According to a further aspect of the present disclosure, one or more computing devices associated with an autonomous vehicle can determine one or more cell statistics characterizing the LIDAR data corresponding to each cell. In some examples, the one or more cell statistics can include, for example, one or more parameters associated with a distribution of LIDAR data points projected onto each cell. For instance, such parameters can include the number of LIDAR data points projected onto each cell, the average, variance, range, minimum and/or maximum value of a parameter for each LIDAR data point. In some examples, the one or more cell statistics can include, for example, one or more parameters associated with a power or intensity of LIDAR data points projected onto each cell.

According to a further aspect of the present disclosure, one or more computing devices associated with an autonomous vehicle can determine a feature extraction vector for each cell based at least in part on the one or more cell statistics for that cell. Additionally or alternatively, a feature extraction vector for each cell can be based at least in part on the one or more cell statistics for surrounding cells. More particularly, in some examples, a feature extraction vector aggregates one or more cell statistics of surrounding cells at one or more different scales. For example, a first scale can correspond to a first group of cells that includes only a given cell. Cell statistics for the first group of cells (e.g., the given cell) can be calculated, a function can be determined based on those cell statistics, and the determined function can be included in a feature extraction vector. A second scale can correspond to a second group of cells that includes the given cell as well as a subset of cells surrounding the given cell. Cell statistics for the second group of cells can be calculated, a function can be determined based on those cell statistics, and the determined function can be appended to the feature extraction vector. A third scale can correspond to a third group of cells that includes the given cell as well as a subset of cells surrounding the given cell, wherein the third group of cells is larger than the second group of cells. Cell statistics for the third group of cells can be calculated, a function can be determined based on those cell statistics, and the determined function can be appended to the feature extraction vector. This process can be continued for a predetermined number of scales until the predetermined number has been reached. Such a multi-scale technique for extracting features can be advantageous in detecting objects of interest having different sizes (e.g., vehicles versus pedestrians).

According to a further aspect of the present disclosure, one or more computing devices associated with an autonomous vehicle can determine a classification for each cell based at least in part on the one or more cell statistics. In some implementations, a classification for each cell can be determined based at least in part on the feature extraction vector determined for each cell. In some implementations, the classification for each call can include an indication of whether that cell includes (or does not include) a detected object of interest. In some examples, the classification for each cell can include an indication of whether that cell includes a detected object of interest from a predetermined set of objects of interest (e.g., a vehicle, a bicycle, a pedestrian, etc.). In some examples, the classification for each cell can include a probability score associated with each classification indicating the likelihood that such cell includes one or more particular classes of objects of interest.

More particularly, in some implementations, determining a classification for each cell can include accessing a classification model. The classification model can have been trained to classify cells of LIDAR data as including or not including detected objects. In some examples, the classification model can include a decision tree classifier. In some implementations, the classification model can be a machine-learned model such as but not limited to a model trained as a neural network, a support-vector machine (SVM) or other machine learning process. The one or more cell statistics for each cell (and/or the feature extraction vector for each cell) can be provided as input to the classification model. In response to receipt of the one or more cell statistics (and/or feature extraction vector) an indication of whether each cell includes a detected object of interest can be received as an output of the classification model.

According to a further aspect of the present disclosure, one or more computing devices associated with an autonomous vehicle can determine object segments based at least in part on the determined classifications for each cell of LIDAR data. More particularly, nearby cells having one or more predetermined classifications can be clustered into one or more groups of cells. In some implementations, nearby cells having a same classification (e.g., proximate cells that are determined as likely including a pedestrian) can be clustered into one or more groups of cells. In some implementations, nearby cells having a classification determined to fall within a predetermined group of classifications (e.g., 50% likely to include a pedestrian, 75% likely to include a pedestrian, and/or 100% likely to include a pedestrian) can be clustered into one or more groups of cells. Each group of cells can correspond to an instance of a detected object of interest. A two-dimensional (2D) bounding shape (e.g., bounding box or other polygon) or a three-dimensional (3D) bounding shape (e.g., rectangular prism or other 3D shape) then can be generated for each instance of a detected object of interest. Each bounding shape can be positioned relative to a corresponding cluster of cells having one or more predetermined classifications such that each bounding shape corresponds to one of the one or more object segments determined in a top-view scene.

More particularly, in some implementations, generating a bounding shape corresponding to each object segment can include generating a plurality of proposed bounding shapes positioned relative to each corresponding cluster of cells. A score for each proposed bounding shape can be determined. In some examples, each score can be based at least in part on a number of cells having one or more predetermined classifications within each proposed bounding shape. The bounding shape ultimately determined for each corresponding cluster of cells (e.g., object instance) can be determined at least in part on the scores for each proposed bounding shape. In some examples, the ultimate bounding shape determination from the plurality of proposed bounding shapes can be additionally or alternatively based on non-maximum suppression (NMS) analysis of the proposed bounding shapes to remove and/or reduce any overlapping bounding boxes.

In some implementations, the classification model used to determine a classification for each cell can also be configured and/or trained to generate a bounding shape and/or parameters used to define a bounding shape. The classification model can have been trained to generate a bounding shape for one or more cells based at least in part on the same cell statistic(s) and/or feature extraction vector(s) used to determine cell classifications. Additionally or alternatively, in some implementations, the model can use the determined cell classifications to generate a bounding box or bounding box parameters that can then be received simultaneously with the cell classifications as an output of the classification model.

An autonomous vehicle can include a sensor system as described above as well as a vehicle computing system. The vehicle computing system can include one or more computing devices and one or more vehicle controls. The one or more computing devices can include a perception system, a prediction system, and a motion planning system that cooperate to perceive the surrounding environment of the autonomous vehicle and determine a motion plan for controlling the motion of the autonomous vehicle accordingly. The vehicle computing system can receive sensor data from the sensor system as described above and utilize such sensor data in the ultimate motion planning of the autonomous vehicle.

In particular, in some implementations, the perception system can receive sensor data from one or more sensors (e.g., one or more ranging systems and/or a plurality of cameras) that are coupled to or otherwise included within the sensor system of the autonomous vehicle. The sensor data can include information that describes the location (e.g., in three-dimensional space relative to the autonomous vehicle) of points that correspond to objects within the surrounding environment of the autonomous vehicle (e.g., at one or more times). As one example, for a LIDAR system, the ranging data from the one or more ranging systems can include the location (e.g., in three-dimensional space relative to the LIDAR system) of a number of points (e.g., LIDAR points) that correspond to objects that have reflected a ranging laser. For example, a LIDAR system can measure distances by measuring the Time of Flight (TOF) that it takes a short laser pulse to travel from the sensor to an object and back, calculating the distance from the known speed of light.

The perception system can identify one or more objects that are proximate to the autonomous vehicle based on sensor data received from the one or more sensor systems. In particular, in some implementations, the perception system can determine, for each object, state data that describes a current state of such object. As examples, the state data for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle versus pedestrian versus bicycle versus other); yaw rate; and/or other state information. In some implementations, the perception system can determine state data for each object over a number of iterations. In particular, the perception system can update the state data for each object at each iteration. Thus, the perception system can detect and track objects (e.g., vehicles, bicycles, pedestrians, etc.) that are proximate to the autonomous vehicle over time, and thereby produce a presentation of the world around an autonomous vehicle along with its state (e.g., a presentation of the objects of interest within a scene at the current time along with the states of the objects).

The prediction system can receive the state data from the perception system and predict one or more future locations and/or moving paths for each object based on such state data. For example, the prediction system can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

The motion planning system can determine a motion plan for the autonomous vehicle based at least in part on one or more predicted future locations and/or moving paths for the object and/or the state data for the object provided by the perception system. Stated differently, given information about the current locations of objects and/or predicted future locations and/or moving paths of proximate objects, the motion planning system can determine a motion plan for the autonomous vehicle that best navigates the autonomous vehicle along the determined travel route relative to the objects at such locations.

As one example, in some implementations, the motion planning system can determine a cost function for each of one or more candidate motion plans for the autonomous vehicle based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle approaches impact with another object and/or deviates from a preferred pathway (e.g., a predetermined travel route).

Thus, given information about the current locations and/or predicted future locations and/or moving paths of objects, the motion planning system can determine a cost of adhering to a particular candidate pathway. The motion planning system can select or determine a motion plan for the autonomous vehicle based at least in part on the cost function(s). For example, the motion plan that minimizes the cost function can be selected or otherwise determined. The motion planning system then can provide the selected motion plan to a vehicle controller that controls one or more vehicle controls (e.g., actuators or other devices that control gas flow, steering, braking, etc.) to execute the selected motion plan.

The systems and methods described herein may provide a number of technical effects and benefits. By using a top-view representation and analysis of LIDAR data as described herein, an object detection system according to embodiments of the present disclosure can provide a technical effect and benefit of more accurately detecting objects of interest and thereby improving the classification and tracking of such objects of interest in a perception system of an autonomous vehicle. For example, performing more accurate segmentation provides for improved tracking by having cleaner segmented objects and provides for improved classification once objects are properly segmented. Such improved object detection accuracy can be particularly advantageous for use in conjunction with vehicle computing systems for autonomous vehicles. Because vehicle computing systems for autonomous vehicles are tasked with repeatedly detecting and analyzing objects in sensor data for tracking and classification of objects of interest (including other vehicles, cyclists, pedestrians, traffic control devices, and the like) and then determining necessary responses to such objects of interest, improved object detection accuracy allows for faster and more accurate object tracking and classification. Improved object tracking and classification can have a direct effect on the provision of safer and smoother automated control of vehicle systems and improved overall performance of autonomous vehicles.

The systems and methods described herein may also provide a technical effect and benefit of improving object segmentation in cases where smaller objects are close to larger objects. Prior segmentation approaches often have difficulty distinguishing smaller instances from larger instances when the instances are close to each other, for example, resulting in a segmentation error where the smaller instance is segmented in as part of the larger instance. In one example, a segmentation error may result in merging a pedestrian into a vehicle that is close by the pedestrian. In such a situation, autonomous vehicle motion planning may determine a vehicle trajectory that does not include as wide a berth as generally preferred when passing a pedestrian. A smaller marginal passing distance may be acceptable when navigating an autonomous vehicle past another vehicle, but a larger marginal passing distance may be preferred when navigating the autonomous vehicle past a pedestrian. The improved object detection systems and methods as described herein provide for improved segmentation whereby smaller instances (e.g., objects such as pedestrians) are not merged with larger instances (e.g., objects such as vehicles) that are nearby.

The systems and methods described herein may also provide resulting improvements to computing technology tasked with object detection, tracking, and classification. The systems and methods described herein may provide improvements in the speed and accuracy of object detection and classification, resulting in improved operational speed and reduced processing requirements for vehicle computing systems, and ultimately more efficient vehicle control.

With reference to the figures, example embodiments of the present disclosure will be discussed in further detail.

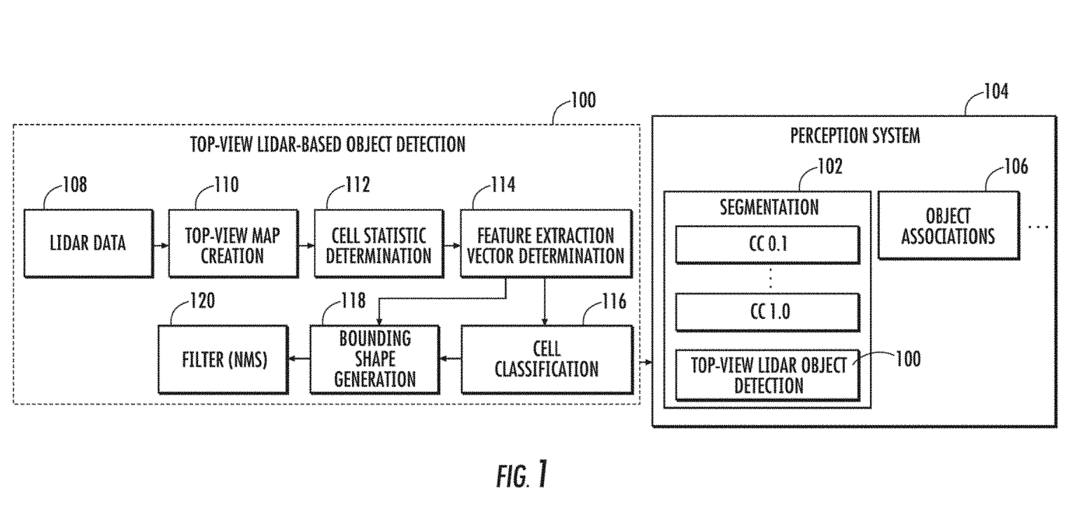

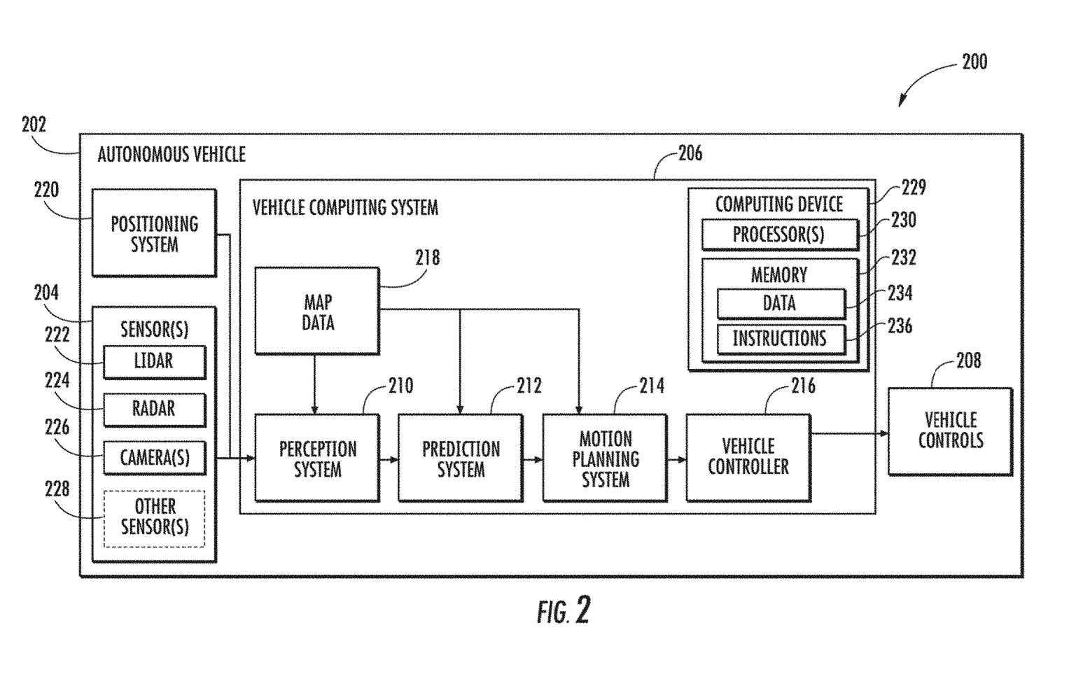

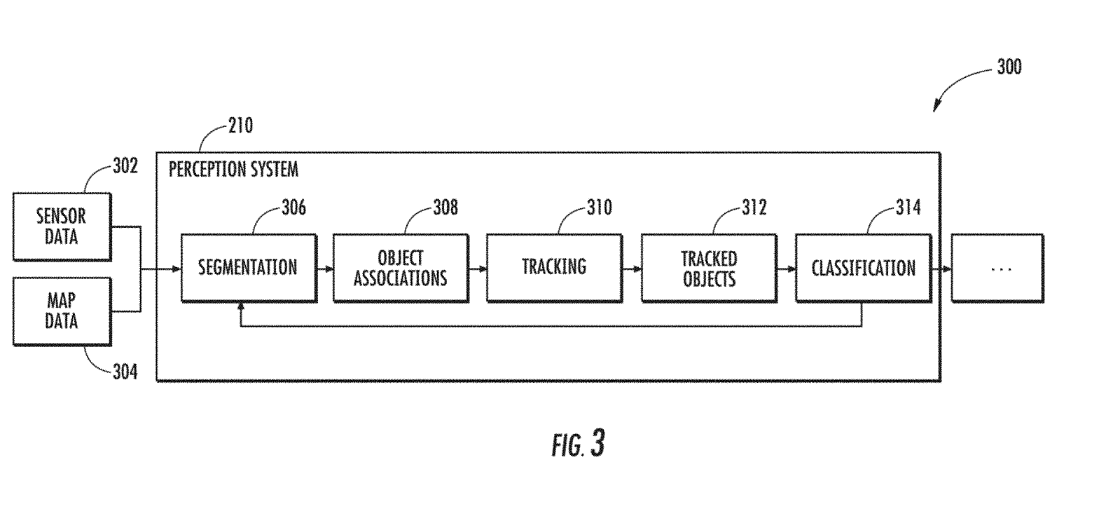

FIG. 1 depicts a block diagram of an example object detection system within a perception system of an autonomous vehicle according to example embodiments of the present disclosure. In particular, FIG. 1 illustrates an example embodiment of a top-view LIDAR-based object detection system 100 which provides object detection in a segmentation system 102 of a perception system 104. The perception system 104 can also include an object associations system 106 and other optional systems configured to collectively contribute to detecting, classifying, associating and/or tracking one or more objects. In some implementations, the segmentation system 102 including top-view LIDAR-based object detection system 100 can generate one or more object segments corresponding to instances of detected objects and provide the object segments to an object application (e.g., an object classification and tracking application) embodied by object associations system 106 or other portions of perception system 104. Additional exemplary details of perception system 104 are described in further detail in FIGS. 2 and 3.

Referring still to FIG. 1, top-view LIDAR-based object detection system 100 can be configured to receive or otherwise obtain LIDAR data 108. In some implementations, LIDAR data 108 can be obtained from one or more LIDAR systems configured to transmit ranging signals relative to an autonomous vehicle and generate LIDAR data 108 based on the ranging signals received back at the LIDAR system(s) after transmission and reflection off objects in the surrounding environment. In some embodiments, LIDAR data 108 can include a three-dimensional point cloud of LIDAR data points received from around the periphery of an autonomous vehicle. For example, LIDAR data 108 can be obtained in response to a LIDAR sweep within an approximately 360 degree field of view around an autonomous vehicle.

In some implementations, top-view LIDAR-based object detection system 100 can more particularly be configured to include one or more systems, including, for example, a top-view map creation system 110, a cell statistic determination system 112, a feature extraction vector determination system 114, a cell classification system 116, a bounding shape generation system 118, and a filter system 120. Each of the top-view map creation system 110, cell statistic determination system 112, feature extraction vector determination system 114, cell classification system 116, bounding shape generation system 118, and filter system 120 can include computer logic utilized to provide desired functionality. In some implementations, each of the top-view map creation system 110, cell statistic determination system 112, feature extraction vector determination system 114, cell classification system 116, bounding shape generation system 118, and filter system 120 can be implemented in hardware, firmware, and/or software controlling a general purpose processor. For example, in some implementations, each of the top-view map creation system 110, cell statistic determination system 112, feature extraction vector determination system 114, cell classification system 116, bounding shape generation system 118, and filter system 120 includes program files stored on a storage device, loaded into a memory, and executed by one or more processors. In other implementations, each of the top-view map creation system 110, cell statistic determination system 112, feature extraction vector determination system 114, cell classification system 116, bounding shape generation system 118, and filter system 120 includes one or more sets of computer-executable instructions that are stored in a tangible computer-readable storage medium such as RAM hard disk or optical or magnetic media.

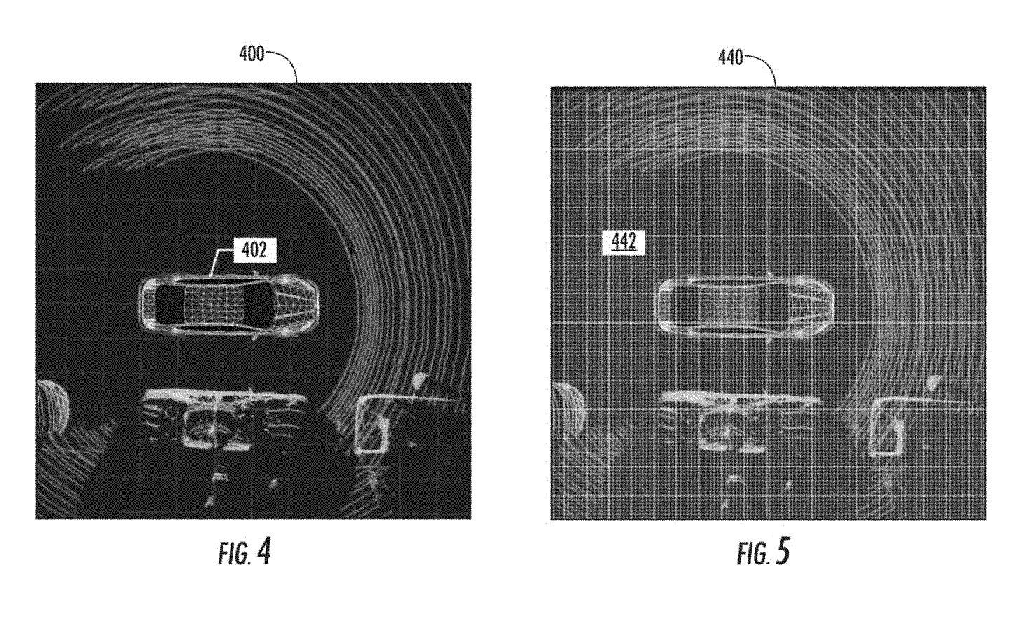

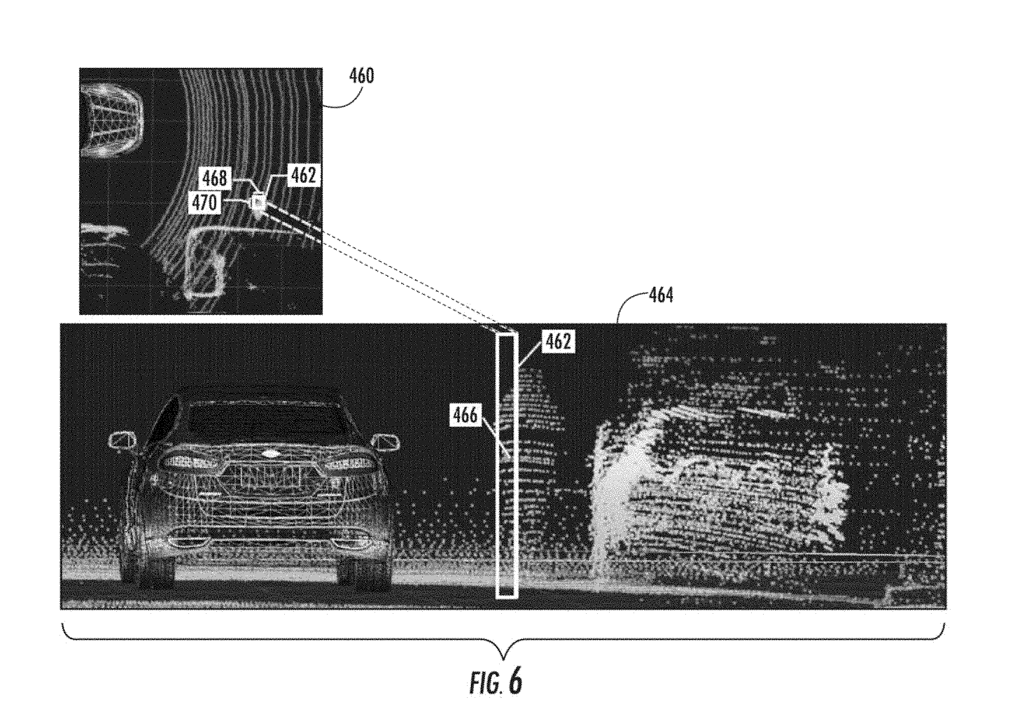

Referring still to FIG. 1, one or more computing devices associated with an autonomous vehicle can generate a top-view map within top-view map creation system 110 of top-view LIDAR-based object detection system 100. Top-view map creation system 110 can generate a top-view representation of LIDAR data that can correspond, for example, to a two-dimensional representation of the LIDAR point cloud looking down from a birds-eye perspective. An example top-view representation of LIDAR data generated by top-view map creation system 110 is depicted in FIG. 4. In some implementations, a top-view representation of LIDAR data generated by top-view map creation system 110 can be discretized into a grid of multiple cells, each cell within the grid corresponding to a column in three-dimensional space. An example top-view representation of LIDAR data discretized into a grid of multiple cells is depicted in FIG. 5, while a visual example of how each cell in a top-view representation corresponds to a column in three-dimensional space is depicted in FIG. 6.

Referring still to FIG. 1, one or more computing devices associated with an autonomous vehicle can determine one or more cell statistics characterizing the LIDAR data corresponding to each cell within cell statistic determination system 112 of top-view LIDAR-based object detection system 100. In some examples, the one or more cell statistics determined within cell statistic determination system 112 can include, for example, one or more parameters associated with a distribution of LIDAR data points projected onto each cell. For instance, such parameters can include the number of LIDAR data points projected onto each cell, the average, variance, range, minimum and/or maximum value of a parameter for each LIDAR data point. In some examples, the one or more cell statistics determined within cell statistic determination system 112 can include, for example, one or more parameters associated with a power or intensity of LIDAR data points projected onto each cell.

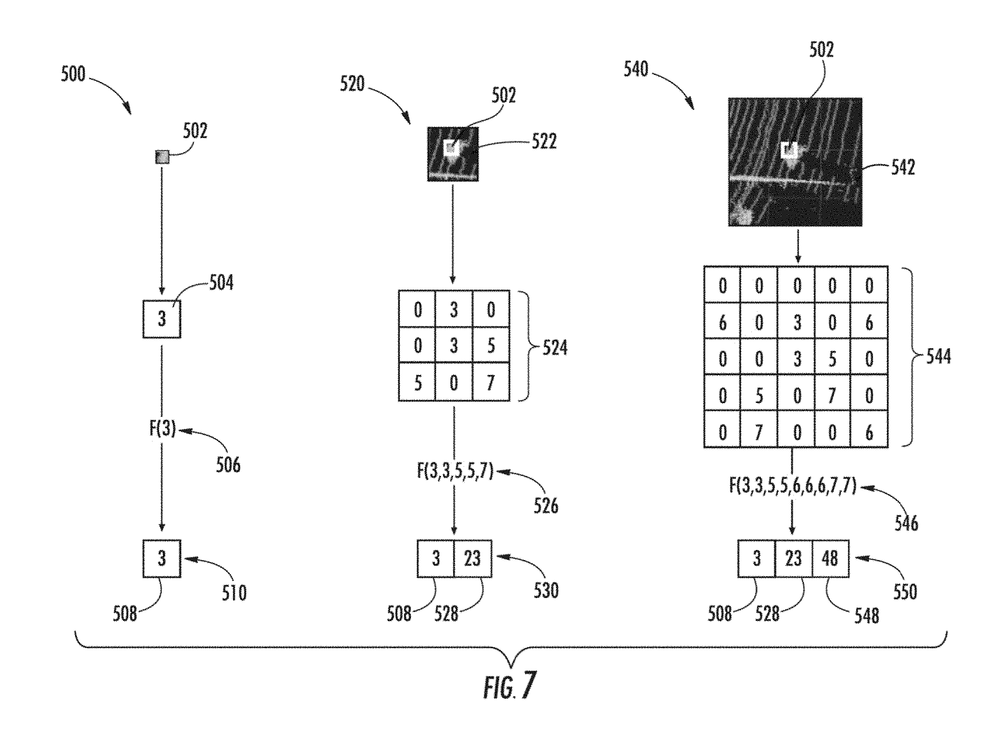

Referring still to FIG. 1, one or more computing devices associated with an autonomous vehicle can determine a feature extraction vector for each cell within feature extraction vector determination system 114 of top-view LIDAR-based object detection system 100. A feature extraction vector determined by feature extraction vector determination system 114 can be based at least in part on the one or more cell statistics for that cell determined by cell statistic determination system 112. Additionally or alternatively, a feature extraction vector determined by feature extraction vector determination system 114 of top-view LIDAR-based object detection system 100 for each cell can be based at least in part on the one or more cell statistics for surrounding cells as determined by cell statistic determination system 112. More particularly, in some examples, a feature extraction vector determined by feature extraction vector determination system 114 aggregates one or more cell statistics of surrounding cells at one or more different scales. Additional exemplary aspects associated with feature extraction vector determination are depicted in FIG. 7.

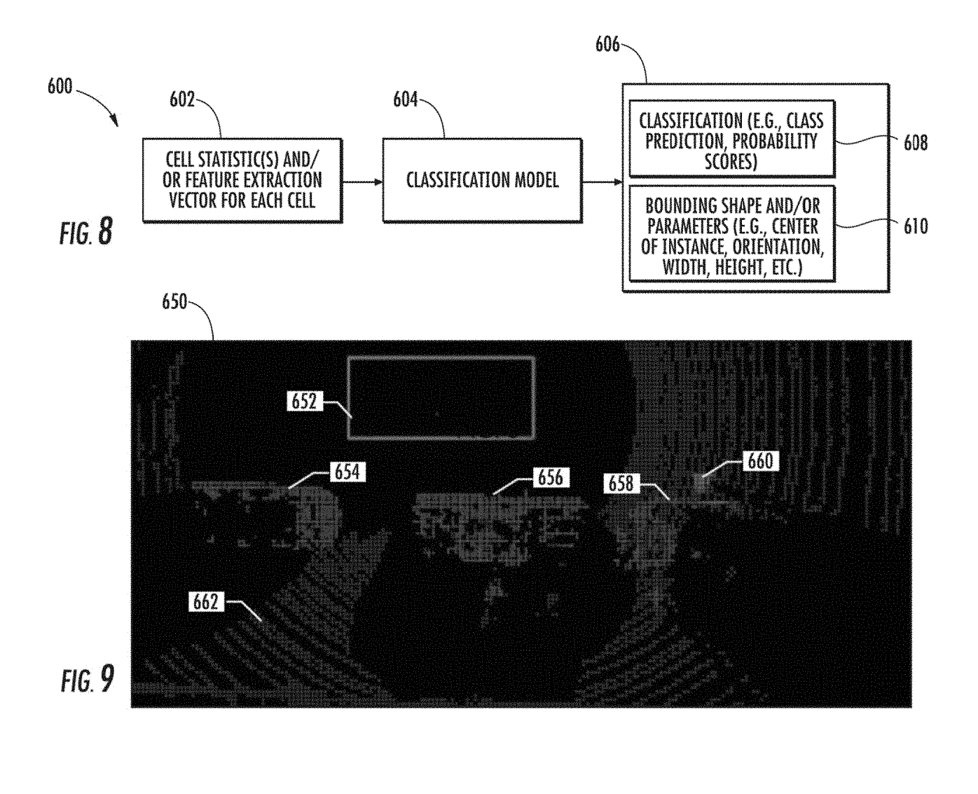

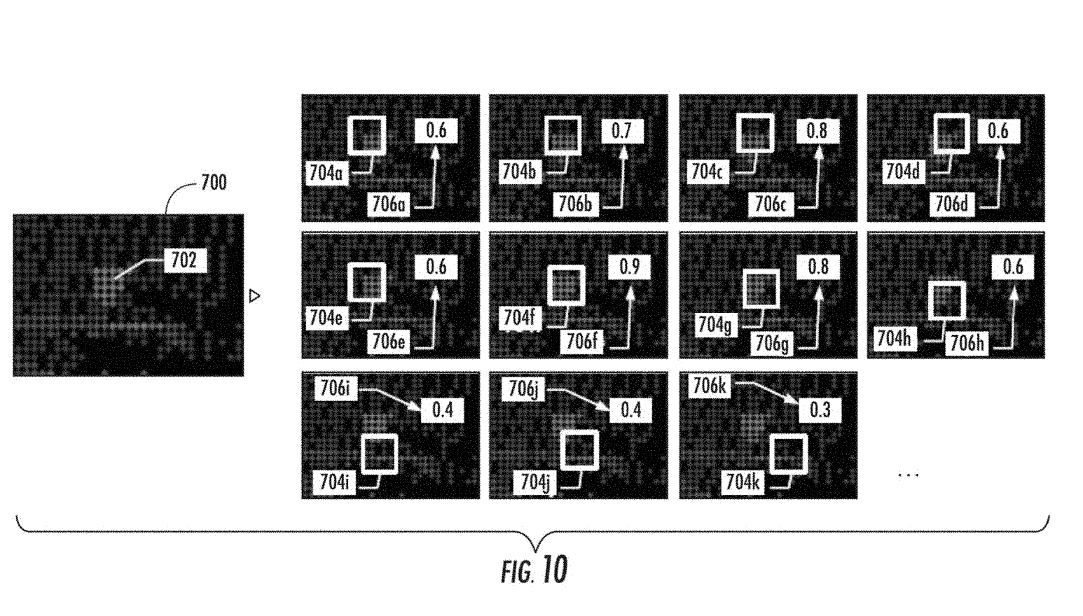

Referring still to FIG. 1, one or more computing devices associated with an autonomous vehicle can determine one or more cell classifications for each cell within cell classification system 116 of top-view LIDAR-based object detection system 100. In some examples, cell classification system 116 determines a classification for each cell or for a selected set of cells within a top-view map based at least in part on the one or more cell statistics determined by cell statistic determination system 112. In some implementations, a classification for each cell can be determined by cell classification system 116 based at least in part on the feature extraction vector determined for each cell by feature extraction vector determination system 114. In some implementations, the classification for each cell can include an indication of whether that cell includes (or does not include) a detected object of interest. In some examples, the classification for each cell can include an indication of whether that cell includes a detected object of interest from a predetermined set of objects of interest (e.g., a vehicle, a bicycle, a pedestrian, etc.). In some examples, the classification for each cell can include a probability score associated with each classification indicating the likelihood that such cell includes one or more particular classes of objects of interest. Additional exemplary details regarding cell classification are provided in FIGS. 8-9.

According to a further aspect of the present disclosure, one or more computing devices associated with an autonomous vehicle can determine bounding shapes for respective instances of detected objects within bounding shape generation system 118 of top-view LIDAR-based object detection system 100. In some implementations, the bounding shapes generated by bounding shape generation system 118 can be based at least in part on the classifications for each cell determined by cell classification system 116. In other implementations, the bounding shapes generated by bounding shape generation system 118 can be based at least in part on the one or more cell statistics determined by cell statistic determination system 112 and/or the feature extraction vector determined for each cell by feature extraction vector determination system 114, similar to the determination of cell classifications.

In some more particular implementations, bounding shape generation system 118 can include a clustering subsystem and a proposed bounding shape generation subsystem. The clustering subsystem within bounding shape generation system 118 can cluster nearby cells having one or more predetermined classifications into one or more groups of cells. Each clustered group of cells can correspond to an instance of a detected object of interest (e.g., an object instance). In some implementations, nearby cells having a same classification (e.g., proximate cells that are determined as likely including a pedestrian) can be clustered into one or more groups of cells. In some implementations, nearby cells having a classification determined to fall within a predetermined group of classifications (e.g., 50% likely to include a pedestrian, 75% likely to include a pedestrian, and/or 100% likely to include a pedestrian) can be clustered into one or more groups of cells.

The proposed bounding shape generation subsystem within bounding shape generation system 118 can generate a plurality of proposed two-dimensional (2D) bounding shapes (e.g., bounding boxes or other polygons) or three-dimensional (3D) bounding shapes (e.g., rectangular prisms or other 3D shapes) for each clustered group of cells corresponding to an instance of a detected object of interest. Each proposed bounding shape can be positioned relative to a corresponding cluster of cells having one or more predetermined classifications such that each proposed bounding shape corresponds to one of the one or more object segments determined in a top-view scene.

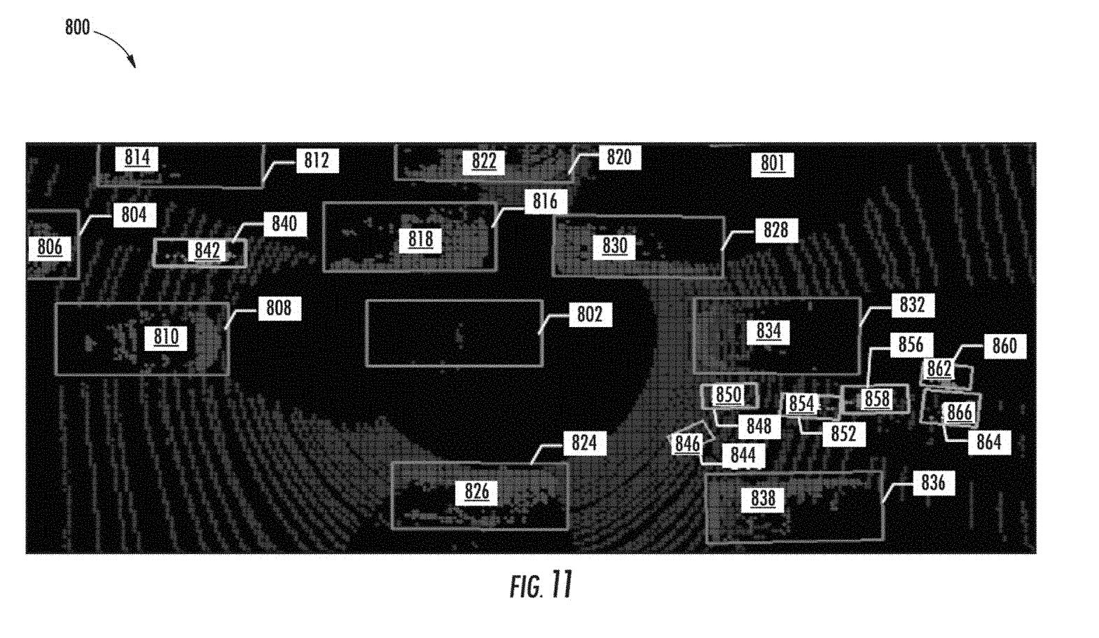

Filtering system 120 can then help to filter the plurality of proposed bounding shapes generated by bounding shape generation system 118. The output of filtering system 120 can correspond, for example, to a bounding shape determined from the plurality of proposed bounding shapes as best corresponding to a particular instance of a detected object. This ultimate bounding shape determination can be referred to as an object segment, which can be provided as an output of top-view LIDAR-based object detection system 100, for example, as an output that is provided to an object classification and tracking application or other application. More particular aspects associated with a bounding shape generation system 118 and filtering system 120 are depicted in and described with reference to FIGS. 10-13.

FIG. 2 depicts a block diagram of an example system 200 for controlling the navigation of an autonomous vehicle 202 according to example embodiments of the present disclosure. The autonomous vehicle 202 is capable of sensing its environment and navigating with little to no human input. The autonomous vehicle 202 can be a ground-based autonomous vehicle (e.g., car, truck, bus, etc.), an air-based autonomous vehicle (e.g., airplane, drone, helicopter, or other aircraft), or other types of vehicles (e.g., watercraft). The autonomous vehicle 202 can be configured to operate in one or more modes, for example, a fully autonomous operational mode and/or a semi-autonomous operational mode. A fully autonomous (e.g., self-driving) operational mode can be one in which the autonomous vehicle can provide driving and navigational operation with minimal and/or no interaction from a human driver present in the vehicle. A semi-autonomous (e.g., driver-assisted) operational mode can be one in which the autonomous vehicle operates with some interaction from a human driver present in the vehicle.

The autonomous vehicle 202 can include one or more sensors 204, a vehicle computing system 206, and one or more vehicle controls 208. The vehicle computing system 206 can assist in controlling the autonomous vehicle 202. In particular, the vehicle computing system 206 can receive sensor data from the one or more sensors 204, attempt to comprehend the surrounding environment by performing various processing techniques on data collected by the sensors 204, and generate an appropriate motion path through such surrounding environment. The vehicle computing system 206 can control the one or more vehicle controls 208 to operate the autonomous vehicle 202 according to the motion path.

The vehicle computing system 206 can include one or more computing devices 229 that respectively include one or more processors 230 and at least one memory 232. The one or more processors 230 can be any suitable processing device (e.g., a processor core, a microprocessor, an ASIC, a FPGA, a controller, a microcontroller, etc.) and can be one processor or a plurality of processors that are operatively connected. The memory 232 can include one or more non-transitory computer-readable storage mediums, such as RAM, ROM, EEPROM, EPROM, flash memory devices, magnetic disks, etc., and combinations thereof. The memory 232 can store data 234 and instructions 236 which are executed by the processor 230 to cause vehicle computing system 206 to perform operations. In some implementations, the one or more processors 230 and at least one memory 232 may be comprised in one or more computing devices, such as computing device(s) 229, within the vehicle computing system 206.

In some implementations, vehicle computing system 206 can further be connected to, or include, a positioning system 220. Positioning system 220 can determine a current geographic location of the autonomous vehicle 202. The positioning system 220 can be any device or circuitry for analyzing the position of the autonomous vehicle 202. For example, the positioning system 220 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position. The position of the autonomous vehicle 202 can be used by various systems of the vehicle computing system 206.

As illustrated in FIG. 2, in some embodiments, the vehicle computing system 206 can include a perception system 210, a prediction system 212, and a motion planning system 214 that cooperate to perceive the surrounding environment of the autonomous vehicle 202 and determine a motion plan for controlling the motion of the autonomous vehicle 202 accordingly.

In particular, in some implementations, the perception system 210 can receive sensor data from the one or more sensors 204 that are coupled to or otherwise included within the autonomous vehicle 202. As examples, the one or more sensors 204 can include a Light Detection and Ranging (LIDAR) system 222, a Radio Detection and Ranging (RADAR) system 224, one or more cameras 226 (e.g., visible spectrum cameras, infrared cameras, etc.), and/or other sensors 228. The sensor data can include information that describes the location of objects within the surrounding environment of the autonomous vehicle 202.

As one example, for LIDAR system 222, the sensor data can include the location (e.g., in three-dimensional space relative to the LIDAR system 222) of a number of points that correspond to objects that have reflected a ranging laser. For example, LIDAR system 222 can measure distances by measuring the Time of Flight (TOF) that it takes a short laser pulse to travel from the sensor to an object and back, calculating the distance from the known speed of light. In some implementations, LIDAR system 222 of FIG. 2 can be configured to obtain LIDAR data 108 of FIG. 1.

As another example, for RADAR system 224, the sensor data can include the location (e.g., in three-dimensional space relative to RADAR system 224) of a number of points that correspond to objects that have reflected a ranging radio wave. For example, radio waves (pulsed or continuous) transmitted by the RADAR system 224 can reflect off an object and return to a receiver of the RADAR system 224, giving information about the object's location and speed. Thus, RADAR system 224 can provide useful information about the current speed of an object.

As yet another example, for one or more cameras 226, various processing techniques (e.g., range imaging techniques such as, for example, structure from motion, structured light, stereo triangulation, and/or other techniques) can be performed to identify the location (e.g., in three-dimensional space relative to the one or more cameras 226) of a number of points that correspond to objects that are depicted in imagery captured by the one or more cameras 226. Other sensor systems 228 can identify the location of points that correspond to objects as well.

Thus, the one or more sensors 204 can be used to collect sensor data that includes information that describes the location (e.g., in three-dimensional space relative to the autonomous vehicle 202) of points that correspond to objects within the surrounding environment of the autonomous vehicle 202.

In addition to the sensor data, the perception system 210 can retrieve or otherwise obtain map data 218 that provides detailed information about the surrounding environment of the autonomous vehicle 202. The map data 218 can provide information regarding: the identity and location of different travelways (e.g., roadways), road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travelway); traffic control data (e.g., the location and instructions of signage, traffic lights, or other traffic control devices); and/or any other map data that provides information that assists the vehicle computing system 206 in comprehending and perceiving its surrounding environment and its relationship thereto.

The perception system 210 can identify one or more objects that are proximate to the autonomous vehicle 202 based on sensor data received from the one or more sensors 204 and/or the map data 218. In particular, in some implementations, the perception system 210 can determine, for each object, state data that describes a current state of such object. As examples, the state data for each object can describe an estimate of the object's: current location (also referred to as position); current speed; current heading (also referred to together as velocity); current acceleration; current orientation; size/footprint (e.g., as represented by a bounding shape such as a bounding polygon or polyhedron); class (e.g., vehicle versus pedestrian versus bicycle versus other); yaw rate; and/or other state information.

In some implementations, the perception system 210 can determine state data for each object over a number of iterations. In particular, the perception system 210 can update the state data for each object at each iteration. Thus, the perception system 210 can detect and track objects (e.g., vehicles, pedestrians, bicycles, and the like) that are proximate to the autonomous vehicle 202 over time.

The prediction system 212 can receive the state data from the perception system 210 and predict one or more future locations and/or moving paths for each object based on such state data. For example, the prediction system 212 can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

The motion planning system 214 can determine a motion plan for the autonomous vehicle 202 based at least in part on the predicted one or more future locations and/or moving paths for the object provided by the prediction system 212 and/or the state data for the object provided by the perception system 210. Stated differently, given information about the current locations of objects and/or predicted future locations and/or moving paths of proximate objects, the motion planning system 214 can determine a motion plan for the autonomous vehicle 202 that best navigates the autonomous vehicle 202 relative to the objects at such locations.

As one example, in some implementations, the motion planning system 214 can determine a cost function for each of one or more candidate motion plans for the autonomous vehicle 202 based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle 202 approaches a possible impact with another object and/or deviates from a preferred pathway (e.g., a preapproved pathway).

Thus, given information about the current locations and/or predicted future locations and/or moving paths of objects, the motion planning system 214 can determine a cost of adhering to a particular candidate pathway. The motion planning system 214 can select or determine a motion plan for the autonomous vehicle 202 based at least in part on the cost function(s). For example, the candidate motion plan that minimizes the cost function can be selected or otherwise determined. The motion planning system 214 can provide the selected motion plan to a vehicle controller 216 that controls one or more vehicle controls 208 (e.g., actuators or other devices that control gas flow, acceleration, steering, braking, etc.) to execute the selected motion plan.

Each of the perception system 210, the prediction system 212, the motion planning system 214, and the vehicle controller 216 can include computer logic utilized to provide desired functionality. In some implementations, each of the perception system 210, the prediction system 212, the motion planning system 214, and the vehicle controller 216 can be implemented in hardware, firmware, and/or software controlling a general purpose processor. For example, in some implementations, each of the perception system 210, the prediction system 212, the motion planning system 214, and the vehicle controller 216 includes program files stored on a storage device, loaded into a memory, and executed by one or more processors. In other implementations, each of the perception system 210, the prediction system 212, the motion planning system 214, and the vehicle controller 216 includes one or more sets of computer-executable instructions that are stored in a tangible computer-readable storage medium such as RAM hard disk or optical or magnetic media.

FIG. 3 depicts a block diagram of an example perception system 210 according to example embodiments of the present disclosure. As discussed in regard to FIG. 2, a vehicle computing system 206 can include a perception system 210 that can identify one or more objects that are proximate to an autonomous vehicle 202. In some embodiments, the perception system 210 can include segmentation system 306, object associations system 308, tracking system 310, tracked objects system 312, and classification system 314. The perception system 310 can receive sensor data 302 (e.g., from one or more sensors 204 of the autonomous vehicle 202) and optional map data 304 (e.g., corresponding to map data 218 of FIG. 2) as input. The perception system 210 can use the sensor data 302 and the map data 304 in determining objects within the surrounding environment of the autonomous vehicle 202. In some embodiments, the perception system 210 iteratively processes the sensor data 302 to detect, track, and classify objects identified within the sensor data 302. In some examples, the map data 304 can help localize the sensor data 302 to positional locations within a map or other reference system.

Within the perception system 210, the segmentation system 306 can process the received sensor data 302 and map data 304 to determine potential objects within the surrounding environment, for example using one or more object detection systems including the disclosed top-view LIDAR-based object detection system 100. The object associations system 308 can receive data about the determined objects and analyze prior object instance data to determine a most likely association of each determined object with a prior object instance, or in some cases, determine if the potential object is a new object instance. Object associations system 308 of FIG. 3 can correspond in some implementations to the object associations system 106 of FIG. 1. The tracking system 310 can determine the current state of each object instance, for example, in terms of its current position, velocity, acceleration, heading, orientation, uncertainties, and/or the like. The tracked objects system 312 can receive data regarding the object instances and their associated state data and determine object instances to be tracked by the perception system 210. The classification system 314 can receive the data from tracked objects system 312 and classify each of the object instances. For example, classification system 314 can classify a tracked object as an object from a predetermined set of objects (e.g., a vehicle, bicycle, pedestrian, etc.). The perception system 210 can provide the object and state data for use by various other systems within the vehicle computing system 206, such as the prediction system 212 of FIG. 2.

Referring now to FIGS. 4-6, various depictions of example top-view representations of LIDAR data are provided. In some implementations, the top-view representations of LIDAR data depicted in FIGS. 4-6 are generated by top-view map creation system 110 of FIG. 1.

FIG. 4 depicts an example top-view representation 400 of LIDAR data generated by top-view map creation system 110 of FIG. 1. Top-view representation 400 includes a depiction of an autonomous vehicle 402 associated with a LIDAR system. In some implementations, autonomous vehicle 402 can correspond to autonomous vehicle 202 of FIG. 2, which is associated with LIDAR system 222. LIDAR system 222 can, for example, be mounted to a location on autonomous vehicle 402 and configured to transmit ranging signals relative to the autonomous vehicle 402 and to generate LIDAR data (e.g., LIDAR data 108). The LIDAR data depicted in FIG. 4 can indicate how far away an object is from the LIDAR system (e.g., the distance to an object struck by a ranging laser beam from the LIDAR system associated with autonomous vehicle 402). The top-view representation of LIDAR data illustrated in FIG. 4 depicts LIDAR points generated from a plurality of ranging laser beams being reflected from objects that are proximate to autonomous vehicle 402.

FIG. 5 provides an example top-view representation 440 of LIDAR data that is discretized into a grid 442 of multiple cells. Grid 442 can be provided as a framework for characterizing the LIDAR data such that respective portions of the LIDAR data can be identified as corresponding to discrete cells within the grid 442 of multiple cells. The LIDAR data can include a plurality of LIDAR data points that are projected onto respective cells within the grid 442 of multiple cells.

For instance, FIG. 6 visually illustrates how each cell in a top-view representation such as depicted in FIG. 5 can correspond to a column in three-dimensional space and can include zero or more LIDAR data points within each cell. More particularly, FIG. 6 provides a top-view representation 460 that is a magnified view of a portion of the LIDAR data contained within top-view representation 400 of FIG. 4 and top-view representation 440 of FIG. 5. Cell 462 in top-view representation 460 is intended to represent one cell within the grid 442 of multiple cells depicted in FIG. 5. Side-view representation 464 of FIG. 6 shows how the same cell 462 can correspond to a column in three-dimensional space and can include zero or more LIDAR data points 466 within that cell 462.

Referring still to FIGS. 5-6, in some implementations, each cell 462 in the grid 442 of multiple cells can be generally rectangular such that each cell 462 is characterized by a first dimension 468 and a second dimension 470. In some implementations, although not required, the first dimension 468 and second dimension 470 of each cell 462 is substantially equivalent such that grid 442 corresponds to a grid of generally square cells. The first dimension 468 and second dimension 470 can be designed to create a suitable resolution based on the types of objects that are desired for detection. In some examples, each cell 462 can be characterized by first and second dimensions 468/470 on the order of between about 5 and 25 centimeters (cm). In some examples, each cell 462 can be characterized by first and second dimensions 468/470 on the order of about 10 cm.

Referring now to FIG. 7, additional aspects associated with feature extraction vector determination are depicted. The example feature extraction vector of FIG. 7 can be determined, for example, by feature extraction vector determination system 114 of FIG. 1. More particularly, FIG. 7 depicts feature extraction vector determination associated with three different scales, namely a first scale 500, a second scale 520 and a third scale 540. For each of the first scale 500, second scale 520, and third scale 540, cell statistics for a group of cells can be calculated, a function can be determined based on those cell statistics, and the determined function can be included in or otherwise utilized in determination of a feature extraction vector.

With more particular reference to FIG. 7, first scale 500 can correspond to a first group of cells that includes only a given cell 502. Cell statistics 504 for the first group of cells (e.g., the given cell 502) can be calculated, a function 506 can be determined based on those cell statistics 504, and the determined function 506 can be included as a first entry 508 in a feature extraction vector 510. Second scale 520 can correspond to a second group of cells 522 that includes the given cell 502 as well as a subset of cells surrounding the given cell 502. In the example of FIG. 7, second group of cells 522 contains (3×3)=9 cells including given cell 502 and eight additional cells surrounding given cell 502 at top, top-right, right, bottom-right, bottom, bottom-left, left and top-left locations relative to given cell 502. Cell statistics 524 for the second group of cells 522 can be calculated, a function 526 can be determined based on those cell statistics 524, and the determined function 526 can be appended to the feature extraction vector 510 to create feature extraction vector 530 that includes function 506 as a first entry 508 and function 526 as a second entry 528. A third scale 540 can correspond to a third group of cells 542 that includes the given cell 502 as well as a subset of cells surrounding the given cell 502, wherein the third group of cells 542 is larger than the second group of cells 522. In the example of FIG. 7, third group of cells 542 contains (5×5)=25 cells including given cell 502. In other words, for each scale (s), the number of cells (n) in the corresponding group of cells can be determined as:

n=(2*s−1)².

Cell statistics 544 for the third group of cells 542 can be calculated, a function 546 can be determined based on those cell statistics 544, and the determined function 546 can be appended to the previous feature extraction vector 530 to create feature extraction vector 550 that includes function 506 as a first entry 508, function 526 as a second entry 528, and function 546 as a third entry 548. This process depicted in FIG. 7 can be continued for a predetermined number of scales until the predetermined number has been reached (e.g., until the feature extraction vector includes a number of entries corresponding to the predetermined number). Such a multi-scale technique for extracting features can be advantageous in detecting objects of interest having different sizes (e.g., vehicles versus pedestrians).

FIG. 8 depicts an example classification model according to example embodiments of the present disclosure. More particularly, FIG. 8 includes example features associated with a cell classification system and/or bounding shape generation system such as cell classification system 116 and bounding shape generation system 118 of FIG. 1. More particularly, in some implementations, determining a classification for each cell can include accessing a classification model 604. The classification model 604 can have been trained to classify cells of LIDAR data and/or generate bounding shapes. The one or more cell statistics for each cell (and/or the feature extraction vector for each cell) 602 can be provided as input to the classification model 604. In response to receipt of the one or more cell statistics (and/or feature extraction vector) 602, one or more parameters can be received as an output 606 of the classification model 604 for each cell.

In some examples, output 606 of classification model 604 can include a first parameter corresponding to a classification 608 for each cell. In some examples, classification 608 can include a class prediction for each cell as corresponding to a particular class of object (e.g., a vehicle, a pedestrian, a bicycle, and/or no object). In some examples, classification 608 can additionally include a probability score associated with the class prediction for each cell. Such a probability score can provide a quantifiable value (e.g., a percentage from 0-100 or value from 0.0-1.0) indicating the likelihood that a given cell includes a particular identified classification. For instance, if classification 608 for a given cell predicted that the cell contained a pedestrian, then an associated probability score could indicate that the pedestrian classification is determined to be about 75% accurate.

In some examples, classification model 604 can also be configured and/or trained to generate a bounding shape and/or parameters used to define a bounding shape. In such examples, output 606 of classification model 604 can also include bounding shapes and/or related parameters 610 for each cell or for a subset of selected cells. Example bounding shapes 610 can be 2D bounding shapes (e.g., bounding boxes or other polygons) or 3D bounding shapes (e.g., prisms or other shapes). Example bounding shape parameters 610 can include, for example, center, orientation, width, height, other dimensions, and the like, which can be used to define a bounding shape.

In some examples, the classification model 604 can include a decision tree classifier. In some implementations, the classification model 604 can be a machine-learned model such as but not limited to a model trained as a neural network, a support-vector machine (SVM) or other machine learning process.

FIG. 9 provides an example graphical depiction of a classification determination according to example embodiments of the present disclosure. For example, FIG. 9 provides a cell classification graph 650, such as could be provided as a visual output of a cell classification system such as cell classification system 116 of FIG. 1. Cell classification graph 650 provides classifications for cells of LIDAR data obtained relative to an autonomous vehicle 652. Cells within cell classification graph 650 can include different visual representations corresponding to different classifications. For instance, cells 654/656/658 for which a first type of classification are determined (e.g., vehicles) can be depicted using a first color, shading or other visual representation, while cells 660 for which a second type of classification are determined (e.g., pedestrians) can be depicted using a second color, shading or other visual representation. Additional types of classifications and corresponding visual representations, including a classification for cells 662 corresponding to “no detected object” can be utilized.

FIG. 10 depicts example aspects associated with bounding shape generation according to example aspects of the present disclosure. More particularly, FIG. 10 includes example features associated with a bounding shape generation system 118 of FIG. 1. FIG. 10 depicts a cell classification graph 700 including a cluster of cells 702 corresponding to an object instance. For example, cluster of cells 702 can correspond to cells 660 of FIG. 9 determined as corresponding to a pedestrian classification. Ultimately, a bounding shape can be determined for cluster of cells 702. In FIG. 10, a plurality of proposed bounding shapes 704a, 704b, 704c, 704d, . . . 704k or beyond can be generated for cluster of cells 702. Each of the proposed bounding shapes 704a, 704b, 704c, 704d, . . . 704k, etc. is positioned in a different location relative to cluster of cells 702. A score 706a, 706b, 706c, 706d, . . . , 706k, etc. can be determined for each proposed bounding shape 704a, 704b, 704c, 704d, . . . , 704k, etc. In some examples, each score 706a, 706b, 706c, 706d, . . . , 706k, etc. can be based at least in part on a number of cells having one or more predetermined classifications (e.g., the number of cells within cluster of cells 702) that are located within each proposed bounding shape 704a, 704b, 704c, 704d, . . . 704k, etc. The bounding shape ultimately determined for each corresponding cluster of cells (e.g., object instance) can be determined at least in part on the scores for each proposed bounding shape. In the example of FIG. 10, for instance, proposed bounding shape 704f can be selected as the bounding shape since it has a highest score 706f among scores 706a, 706b, 706c, 706d, . . . , 706k, etc. for all proposed bounding shapes 704a, 704b, 704c, 704d, . . . 704k, etc. In some examples, the ultimate bounding shape determination from the plurality of proposed bounding shapes 704a, 704b, 704c, 704d, . . . , 704k, etc. can be additionally or alternatively based on a non-maximum suppression (NMS) analysis of the proposed bounding shapes 704a, 704b, 704c, 704d, . . . , 704k, etc. to remove and/or reduce any overlapping bounding boxes. NMS analysis or other filtering technique applied to the proposed bounding shapes 704a, 704b, 704c, 704d, . . . 704k, etc. can be implemented, for example, by filter system 120 of FIG. 1.

FIG. 11 provides a graphical depiction of example classification determinations and object segments according to example aspects of the present disclosure. More particularly, FIG. 11 provides a cell classification and segmentation graph 800 such as could be generated by top-view LIDAR-based object detection system 100 of FIG. 1. Cell classification and segmentation graph 800 can include classifications for cells of LIDAR data as well as object instances determined at least in part from the cell classifications. Determined object instances can use the cell classifications to identify detected objects of interest in the environment proximate to a sensor system for an autonomous vehicle.

The cell classification and segmentation graph 800 of FIG. 11 depicts an environment 801 surrounding an autonomous vehicle 802 with cells of LIDAR data that are classified in accordance with the disclosed technology. Nine object instances are depicted in FIG. 11 as corresponding to detected vehicles in the environment 801. These nine object instances (e.g., vehicles) are depicted by bounding box 804 associated with cluster of cells 806, bounding box 808 associated with cluster of cells 810, bounding box 812 associated with cluster of cells 814, bounding box 816 associated with cluster of cells 818, bounding box 820 associated with cluster of cells 822, bounding box 824 associated with cluster of cells 826, bounding box 828 associated with cluster of cells 830, bounding box 832 associated with cluster of cells 834, and bounding box 836 associated with cluster of cells 838. In addition, seven object instances are depicted in FIG. 11 as corresponding to detected bicycles in the environment 801. These seven object instances (e.g., bicycles) are depicted by bounding box 840 associated with cluster of cells 842, bounding box 844 associated with cluster of cells 846, bounding box 848 associated with cluster of cells 850, bounding box 852 associated with cluster of cells 854, bounding box 856 associated with cluster of cells 858, bounding box 860 associated with cluster of cells 862, and bounding box 864 associated with cluster of cells 866. It should be appreciated that cell classification and segmentation graphs such as depicted in FIG. 11 can include different detected classes of vehicles, such as including pedestrians and other objects of interest. FIG. 11 is provided as merely an example of how object instances can be determined from clusters of classified cells for which corresponding bounding shapes are determined.

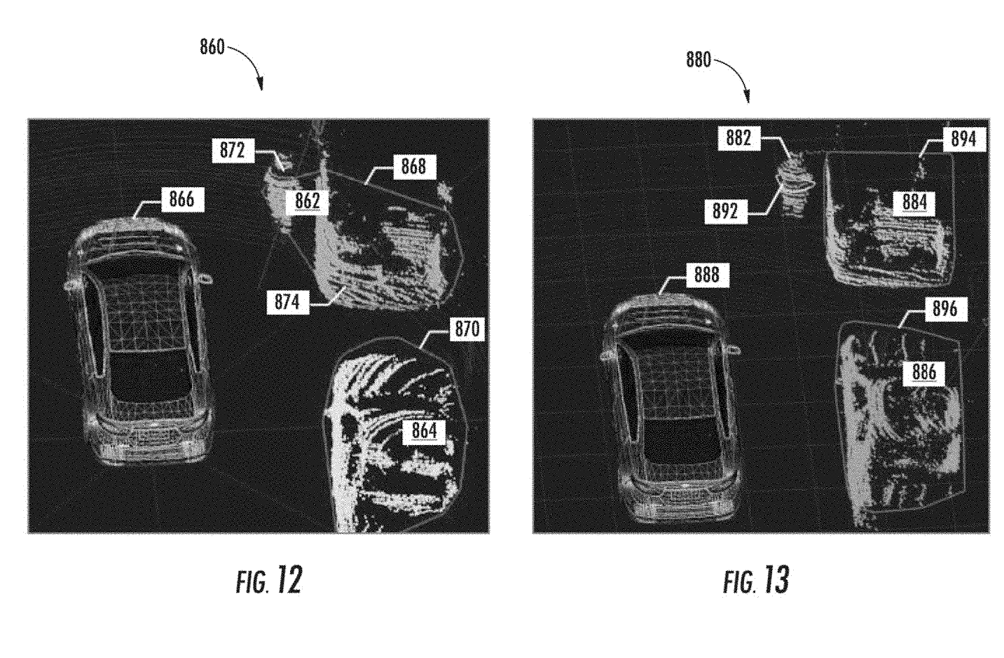

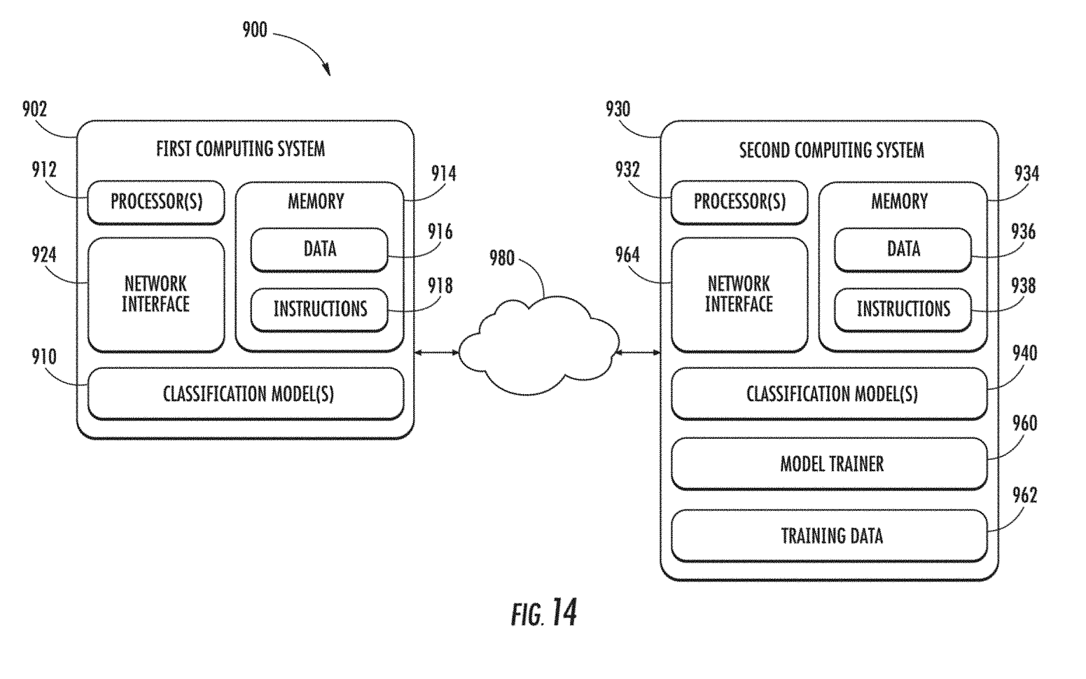

Referring now to FIGS. 12-13, respective illustrations depict actual results of detected object instances without utilizing top-view LIDAR-based object detection (e.g., as depicted in FIG. 12) and with utilizing top-view LIDAR-based object detection according to example aspects of the present disclosure (e.g., as depicted in FIG. 13).

In FIG. 12, cell classification and segmentation graph 860 depicts a first group of cells 862 of LIDAR data and a second group of cells 864 of LIDAR data determined in an environment surrounding autonomous vehicle 866. The first group of cells 862 is determined as corresponding to an object instance, namely a vehicle, represented by bounding shape 868, while the second group of cells 864 is determined as corresponding to another object instance, namely a vehicle, represented by bounding shape 870. In the cell classification and segmentation graph 860 of FIG. 12, object detection technology that does not utilize the disclosed top-view LIDAR-based object detection features fails to distinguish between a first portion of cells 872 and a second portion of cells 874 within first group of cells 862. This may be due in part to limitations of such technology whereby it is difficult to distinguish smaller instances from larger instances when the instances are close to each other. In the particular example of FIG. 12, a segmentation error may result in merging the first portion of cells 872 associated with a pedestrian with the second portion of cells 874 associated with a vehicle into a single object instance represented by bounding shape 868.

In FIG. 13, cell classification and segmentation graph 880 depicts a first group of cells 882 of LIDAR data, a second group of cells 884 of LIDAR data, and a third group of cells 886 of LIDAR data determined in an environment surrounding autonomous vehicle 888. The first group of cells 882 is determined as corresponding to an object instance, namely a pedestrian, represented by bounding shape 892. The second group of cells 884 is determined as corresponding to another object instance, namely a vehicle, represented by bounding shape 894. The third group of cells 886 is determined as corresponding to another object instance, namely a vehicle, represented by bounding shape 896. In the cell classification and segmentation graph 880 of FIG. 13, object detection technology utilizes the disclosed top-view LIDAR-based object detection features and is advantageously able to distinguish between the pedestrian instance represented by bounding shape 892 and the vehicle instance represented by bounding shape 894 even though these object instances are in close proximity to one another. This more accurate classification depicted in FIG. 13 can result in improved object segmentation as well as vehicle motion planning that effectively takes into account the presence of a pedestrian.

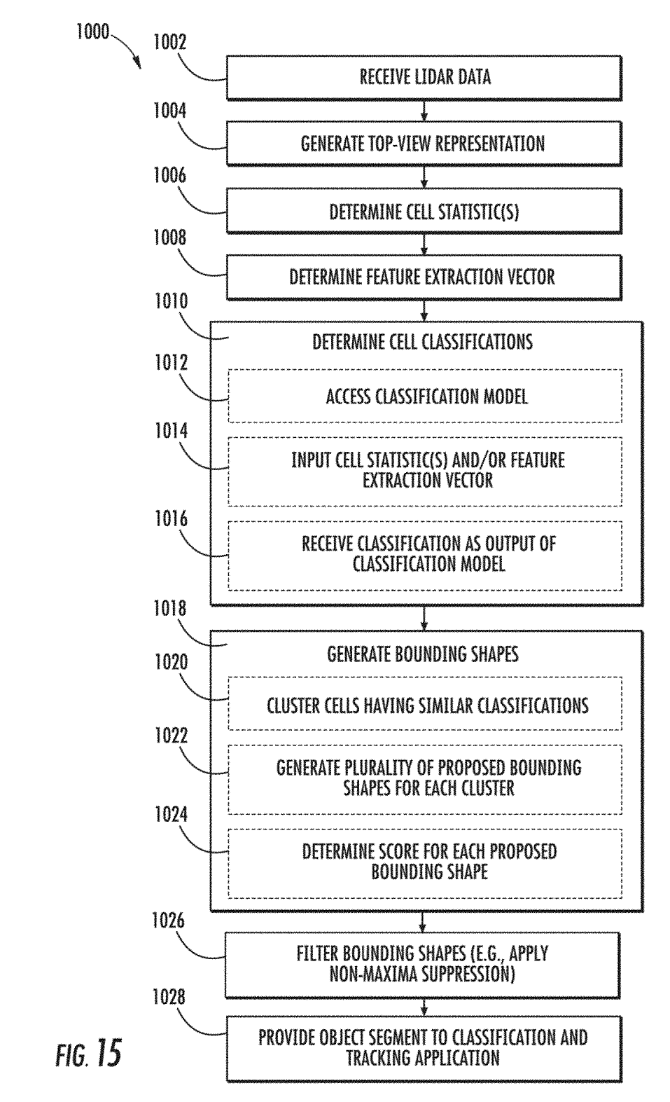

FIG. 14 depicts a block diagram of an example system 900 according to example embodiments of the present disclosure. The example system 900 includes a first computing system 902 and a second computing system 930 that are communicatively coupled over a network 980. In some implementations, the first computing system 902 can perform autonomous vehicle motion planning including object detection, tracking, and/or classification (e.g., making object class predictions and object location/orientation estimations as described herein). In some implementations, the first computing system 902 can be included in an autonomous vehicle. For example, the first computing system 902 can be on-board the autonomous vehicle. In other implementations, the first computing system 902 is not located on-board the autonomous vehicle. For example, the first computing system 902 can operate offline to perform object detection including making object class predictions and object location/orientation estimations. The first computing system 902 can include one or more distinct physical computing devices.

The first computing system 902 includes one or more processors 912 and a memory 914. The one or more processors 912 can be any suitable processing device (e.g., a processor core, a microprocessor, an ASIC, a FPGA, a controller, a microcontroller, etc.) and can be one processor or a plurality of processors that are operatively connected. The memory 914 can include one or more non-transitory computer-readable storage media, such as RAM, ROM, EEPROM, EPROM, one or more memory devices, flash memory devices, etc., and combinations thereof.

The memory 914 can store information that can be accessed by the one or more processors 912. For instance, the memory 914 (e.g., one or more non-transitory computer-readable storage mediums, memory devices) can store data 916 that can be obtained, received, accessed, written, manipulated, created, and/or stored. The data 916 can include, for instance, ranging data obtained by LIDAR system 222 and/or RADAR system 224, image data obtained by camera(s) 226, data identifying detected and/or classified objects including current object states and predicted object locations and/or trajectories, motion plans, machine-learned models, rules, etc. as described herein. In some implementations, the first computing system 902 can obtain data from one or more memory device(s) that are remote from the first computing system 902.

The memory 914 can also store computer-readable instructions 918 that can be executed by the one or more processors 912. The instructions 918 can be software written in any suitable programming language or can be implemented in hardware. Additionally, or alternatively, the instructions 918 can be executed in logically and/or virtually separate threads on processor(s) 912.

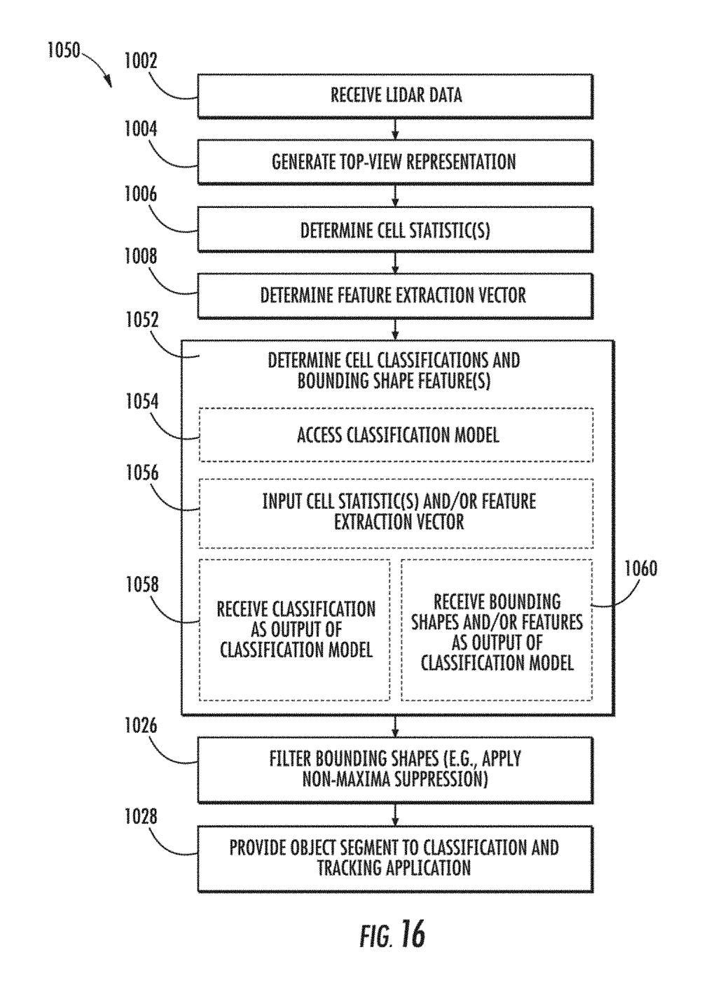

For example, the memory 914 can store instructions 918 that when executed by the one or more processors 912 cause the one or more processors 912 to perform any of the operations and/or functions described herein, including, for example, operations 1002-1028 of FIG. 15.

According to an aspect of the present disclosure, the first computing system 902 can store or include one or more classification models 910. As examples, the classification models 910 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, convolutional neural networks, recurrent neural networks (e.g., long short-term memory recurrent neural networks), or other forms of neural networks.

In some implementations, the first computing system 902 can receive the one or more classification models 910 from the second computing system 930 over network 980 and can store the one or more classification models 910 in the memory 914. The first computing system 902 can then use or otherwise implement the one or more classification models 910 (e.g., by processor(s) 912). In particular, the first computing system 902 can implement the classification model(s) 910 to perform object detection including determining cell classifications and corresponding optional probability scores. For example, in some implementations, the first computing system 902 can employ the classification model(s) 910 by inputting a feature extraction vector for each cell into the classification model(s) 910 and receiving a prediction of the class of one or more LIDAR data points located within that cell as an output of the classification model(s) 910.

The second computing system 930 includes one or more processors 932 and a memory 934. The one or more processors 932 can be any suitable processing device (e.g., a processor core, a microprocessor, an ASIC, a FPGA, a controller, a microcontroller, etc.) and can be one processor or a plurality of processors that are operatively connected. The memory 934 can include one or more non-transitory computer-readable storage media, such as RAM, ROM, EEPROM, EPROM, one or more memory devices, flash memory devices, etc., and combinations thereof.

The memory 934 can store information that can be accessed by the one or more processors 932. For instance, the memory 934 (e.g., one or more non-transitory computer-readable storage mediums, memory devices) can store data 936 that can be obtained, received, accessed, written, manipulated, created, and/or stored. The data 936 can include, for instance, ranging data, image data, data identifying detected and/or classified objects including current object states and predicted object locations and/or trajectories, motion plans, machine-learned models, rules, etc. as described herein. In some implementations, the second computing system 930 can obtain data from one or more memory device(s) that are remote from the second computing system 930.

The memory 934 can also store computer-readable instructions 938 that can be executed by the one or more processors 932. The instructions 938 can be software written in any suitable programming language or can be implemented in hardware. Additionally, or alternatively, the instructions 938 can be executed in logically and/or virtually separate threads on processor(s) 932.

For example, the memory 934 can store instructions 938 that when executed by the one or more processors 932 cause the one or more processors 932 to perform any of the operations and/or functions described herein, including, for example, operations 1002-1028 of FIG. 15.

In some implementations, the second computing system 930 includes one or more server computing devices. If the second computing system 930 includes multiple server computing devices, such server computing devices can operate according to various computing architectures, including, for example, sequential computing architectures, parallel computing architectures, or some combination thereof.

In addition or alternatively to the classification model(s) 910 at the first computing system 902, the second computing system 930 can include one or more classification models 940. As examples, the classification model(s) 940 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, convolutional neural networks, recurrent neural networks (e.g., long short-term memory recurrent neural networks), or other forms of neural networks.

As an example, the second computing system 930 can communicate with the first computing system 902 according to a client-server relationship. For example, the second computing system 930 can implement the classification models 940 to provide a web service to the first computing system 902. For example, the web service can provide an autonomous vehicle motion planning service.

Thus, classification models 910 can be located and used at the first computing system 902 and/or classification models 940 can be located and used at the second computing system 930.

In some implementations, the second computing system 930 and/or the first computing system 902 can train the classification models 910 and/or 940 through use of a model trainer 960. The model trainer 960 can train the classification models 910 and/or 940 using one or more training or learning algorithms. In some implementations, the model trainer 960 can perform supervised training techniques using a set of labeled training data. In other implementations, the model trainer 960 can perform unsupervised training techniques using a set of unlabeled training data. The model trainer 960 can perform a number of generalization techniques to improve the generalization capability of the models being trained. Generalization techniques can include weight decays, dropouts, or other techniques.

In particular, the model trainer 960 can train a machine-learned model 910 and/or 940 based on a set of training data 962. The training data 962 can include, for example, a plurality of sets of ground truth data, each set of ground truth data including a first portion and a second portion. The first portion of ground truth data can include example cell statistics or feature extraction vectors for each cell in a grid (e.g., feature extraction vectors such as depicted in FIG. 7), while the second portion of ground truth data can correspond to predicted classifications for each cell (e.g., classifications such as depicted in FIG. 9) that are manually and/or automatically labeled as correct or incorrect.

The model trainer 960 can train a classification model 910 and/or 940, for example, by using one or more sets of ground truth data in the set of training data 962. For each set of ground truth data including a first portion (e.g., a feature extraction vector) and second portion (e.g., corresponding cell classification), model trainer 960 can: provide the first portion as input into the classification model 910 and/or 940; receive at least one predicted classification as an output of the classification model 910 and/or 940; and evaluate an objective function that describes a difference between the at least one predicted classification received as an output of the classification model 910 and/or 940 and the second portion of the set of ground truth data. The model trainer 960 can train the classification model 910 and/or 940 based at least in part on the objective function. As one example, in some implementations, the objective function can be back-propagated through the classification model 910 and/or 940 to train the classification model 910 and/or 940. In such fashion, the classification model 910 and/or 940 can be trained to provide a correct classification based on the receipt of cell statistics and/or feature extraction vectors generated in part from top-view LIDAR data. The model trainer 960 can be implemented in hardware, firmware, and/or software controlling one or more processors.

The first computing system 902 can also include a network interface 924 used to communicate with one or more systems or devices, including systems or devices that are remotely located from the first computing system 902. The network interface 924 can include any circuits, components, software, etc. for communicating with one or more networks (e.g., 980). In some implementations, the network interface 924 can include, for example, one or more of a communications controller, receiver, transceiver, transmitter, port, conductors, software, and/or hardware for communicating data. Similarly, the second computing system 930 can include a network interface 964.

The network(s) 980 can be any type of network or combination of networks that allows for communication between devices. In some embodiments, the network(s) can include one or more of a local area network, wide area network, the Internet, secure network, cellular network, mesh network, peer-to-peer communication link, and/or some combination thereof, and can include any number of wired or wireless links. Communication over the network(s) 980 can be accomplished, for instance, via a network interface using any type of protocol, protection scheme, encoding, format, packaging, etc.

FIG. 14 illustrates one example system 900 that can be used to implement the present disclosure. Other computing systems can be used as well. For example, in some implementations, the first computing system 902 can include the model trainer 960 and the training dataset 962. In such implementations, the classification models 910 can be both trained and used locally at the first computing system 902. As another example, in some implementations, the first computing system 902 is not connected to other computing systems.

In addition, components illustrated and/or discussed as being included in one of the computing systems 902 or 930 can instead be included in another of the computing systems 902 or 930. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

FIG. 15 depicts a flowchart diagram of a first example method 1000 of top-view LIDAR-based object detection according to example embodiments of the present disclosure. One or more portion(s) of the method 1000 can be implemented by one or more computing devices such as, for example, the computing device(s) 229 within vehicle computing system 206 of FIG. 2, or first computing system 902 or second computing system 930 of FIG. 9. Moreover, one or more portion(s) of the method 1000 can be implemented as an algorithm on the hardware components of the device(s) described herein (e.g., as in FIGS. 1, 2, 3, and 9) to, for example, detect objects within sensor data.

At 1002, one or more computing devices within a computing system can receive LIDAR data. LIDAR data received at 1002 can be received or otherwise obtained from one or more LIDAR systems configured to transmit ranging signals relative to an autonomous vehicle. LIDAR data obtained at 1002 can correspond, for example, to LIDAR data 108 of FIG. 1 and/or data generated by or otherwise obtained at LIDAR system 222 of FIG. 2.

At 1004, one or more computing devices within a computing system can generate a top-view representation of the LIDAR data received at 1002. The top-view representation of LIDAR data generated at 1004 can be discretized into a grid of multiple cells. In some implementations, each cell in the grid of multiple cells represents a column in three-dimensional space. The top-view representation of LIDAR data generated at 1004 can be generated, for example, by top-view map creation system 110 of FIG. 1. Example depictions of top-view representations of LIDAR data generated at 1004 are provided in FIGS. 4 and 5.

At 1006, one or more computing devices within a computing system can determine one or more cell statistics characterizing the LIDAR data corresponding to each cell. In some implementations, the one or more cell statistics determined at 1006 for characterizing the LIDAR data corresponding to each cell can include, for example, one or more parameters associated with a distribution, a power, or intensity of LIDAR data points projected onto each cell.

At 1008, one or more computing devices within a computing system can determine a feature extraction vector for each cell. The feature extraction vector determined at 1008 can be determined, for example, by aggregating one or more cell statistics of surrounding cells at one or more different scales, such as described relative to the example of FIG. 7.

At 1010, one or more computing devices within a computing system can determine a classification for each cell based at least in part on the one or more cell statistics determined at 1006 and/or the feature extraction vector for each cell determined at 1008. For example, the classification for each cell can include an indication of whether that cell includes a detected object of interest from a predetermined set of objects of interest. In some implementations, the classification determined at 1008 can additionally include a probability score associated with each classification. Example aspects associated with determining cell classifications at 1010 are depicted, for instance, in FIGS. 8-9.

Referring still to determining cell classifications at 1010, some implementations can more particularly include accessing a classification model at 1012. The classification model accessed at 1012 can have been trained to classify cells of LIDAR data as corresponding to an object classification determined from a predetermined set of classifications (e.g., vehicle, pedestrian, bicycle, no object). Determining cell classifications at 1010 can further include inputting at 1014 the one or more cell statistics determined at 1006 and/or the one or more feature extraction vectors determined at 1008 to the classification model accessed at 1012 for each cell of LIDAR data. Determining cell classifications at 1010 can further include receiving at 1016 a classification for each cell as an output of the classification model. The output of the classification model received at 1016 can include, for example, an indication of a type of object classification (e.g., vehicle, pedestrian, bicycle, no object) determined for each cell.

At 1018, one or more computing devices within a computing system can generate one or more bounding shapes based at least in part on the classifications for each cell determined at 1010. In some implementations, generating one or more bounding shapes at 1018 can more particularly include clustering cells having one or more predetermined classifications into one or more groups of cells at 1020. Each group of cells clustered at 1020 can correspond to an instance of a detected object of interest (e.g., a vehicle, pedestrian, bicycle or the like).

Generating one or more bounding shapes at 1018 can further include generating a plurality of proposed bounding shapes for each instance of a detected object of interest, each bounding shape positioned relative to a corresponding group of cells clustered at 1020. For instance, generating a plurality of proposed bounding shapes at 1020 can include generating a plurality of proposed bounding shapes at 1022 for each group of cells clustered at 1020. A score can be determined at 1024 for each proposed bounding shape generated at 1022. For example, the score determined at 1024 for each proposed bounding shape generated at 1022 can be based at least in part on a number of cells having one or more predetermined classifications within each proposed bounding shape.

At 1026, one or more computing devices within a computing system can filter the plurality of bounding shapes generated at 1018. In some examples, filtering at 1026 can be based at least in part on the scores determined at 1024 for each proposed bounding box. In some examples, filtering at 1026 can additionally or alternatively include application of a bounding box filtering technique to remove and/or reduce redundant bounding boxes corresponding to a given object instance. For example, non-maximum suppression (NMS) analysis can be implemented as part of the filtering at 1026. Filtering at 1026 can result in determining one of the plurality of proposed bounding shapes generated at 1022 as a best match for each object instance. This best match can be determined as the bounding shape corresponding to an object segment. Example aspects associated with generating bounding shapes at 1018 and filtering bounding shapes at 1026 are depicted, for instance, in FIGS. 10-13.

At 1028, one or more computing devices within a computing system can provide the one or more object segments determined after filtering at 1026 to an object classification and tracking application. In some implementations, additional information beyond the object segments determined after filtering at 1026 (e.g., the cell classifications determined at 1010) can also be provided to an object classification and tracking application at 1028. An object classification and tracking application to which object segments and/or cell classifications can be provided may correspond, for example, one or more portions of a perception system such as perception system 206 of FIG. 3.

FIG. 16 depicts a flowchart diagram of a second example method 1050 of top-view LIDAR-based object detection according to example embodiments of the present disclosure. One or more portion(s) of the method 1000 can be implemented by one or more computing devices such as, for example, the computing device(s) 229 within vehicle computing system 206 of FIG. 2, or first computing system 902 or second computing system 930 of FIG. 9. Moreover, one or more portion(s) of the method 1000 can be implemented as an algorithm on the hardware components of the device(s) described herein (e.g., as in FIGS. 1, 2, 3, and 9) to, for example, detect objects within sensor data.

Some aspects of FIG. 16 are similar to those previously described relative to FIG. 15, and the description of such similar aspects is intended to equally apply to both figures. With more particular reference to FIG. 16, second example method 1050 generally sets forth an example in which cell classifications and bounding shapes (or bounding shape features) are simultaneously determined as respective outputs of a classification model. For instance, one or more computing devices within a computing system can determine cell classifications and bounding shapes (or bounding shape features) at 1052. In some implementations, determining cell classifications and bounding shapes at 1052 can more particularly include accessing a classification model at 1054. The classification model accessed at 1054 can have been trained to classify cells of LIDAR data and/or generate bounding shapes. The one or more cell statistics for each cell (and/or the feature extraction vector for each cell) can be provided as input to the classification model at 1054. In response to receipt of the one or more cell statistics (and/or feature extraction vector) 602, one or more parameters can be received as an output of the classification model. For example, a classification for each cell can be received as an output of the classification model at 1058 while a bounding shape (or features for defining a bounding shape) can be simultaneously received as an output of the classification model at 1060. The classification received at 1058 can include a class prediction for each cell as corresponding to a particular class of object (e.g., a vehicle, a pedestrian, a bicycle, and/or no object), along with an optional probability score associated with the class prediction for each cell. The bounding shape and/or bounding shape parameters received at 1060 can be received for each cell or for a subset of selected cells. Example bounding shapes received at 1060 can be 2D bounding shapes (e.g., bounding boxes or other polygons) or 3D bounding shapes (e.g., prisms or other shapes). Example bounding shape parameters received at 1060 can include, for example, center, orientation, width, height, other dimensions, and the like, which can be used to define a bounding shape.

Although FIGS. 15 and 16 depicts steps performed in a particular order for purposes of illustration and discussion, the methods of the present disclosure are not limited to the particularly illustrated order or arrangement. The various steps of the method 1000 can be omitted, rearranged, combined, and/or adapted in various ways without deviating from the scope of the present disclosure.

Computing tasks discussed herein as being performed at computing device(s) remote from the autonomous vehicle can instead be performed at the autonomous vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices. While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for detecting objects of interest, comprising:
receiving, by a computing system that comprises one or more computing devices, LIDAR data from one or more LIDAR systems configured to transmit ranging signals relative to an autonomous vehicle;
generating, by the computing system, a top-view representation of the LIDAR data that is discretized into a grid of multiple cells;
determining, by the computing system, one or more cell statistics characterizing the LIDAR data corresponding to each cell; and
determining, by the computing system, a classification for each cell based at least in part on the one or more cell statistics.

2. The method of claim 1, wherein each cell in the grid of multiple cells represents a column in three-dimensional space.

3. The method of claim 1, wherein the classification for each cell comprises an indication of whether that cell includes a detected object of interest from a predetermined set of objects of interest and a probability score associated with each classification.

4. The method of claim 1, further comprising:
generating, by the computing system, one or more object segments based at least in part on the classification for each cell; and
providing, by the computing system, the one or more object segments to an object classification and tracking application.

5. The method of claim 4, wherein generating, by the computing system, one or more object segments based at least in part on the classification for each cell comprises:
clustering, by the computing system, cells having one or more predetermined classifications into one or more groups of cells, each group corresponding to an instance of a detected object of interest; and
generating, by the computing system, a bounding shape for each instance of a detected object of interest, each bounding shape positioned relative to a corresponding cluster of cells having one or more predetermined classifications, each bounding shape corresponding to one of the one or more object segments.

6. The method of claim 5, wherein generating, by the computing system, a bounding shape positioned relative to a corresponding cluster of cells comprises:
generating, by the computing system, a plurality of proposed bounding shapes positioned relative to each corresponding cluster of cells;
determining, by the computing system, a score for each proposed bounding shape based at least in part on a number of cells having one or more predetermined classifications within each proposed bounding shape; and
determining, by the computing system, the bounding shape for each corresponding cluster of cells based at least in part on the scores for each proposed bounding shape and a non-maximum suppression analysis of the proposed bounding shapes.

7. The computer-implemented method of claim 1, wherein the one or more cell statistics characterizing the LIDAR data corresponding to each cell comprises one or more parameters associated with a distribution, a power, or intensity of LIDAR data points projected onto each cell.

8. The method of claim 1, further comprising:
determining, by the computing system, a feature extraction vector for each cell by aggregating the one or more cell statistics of surrounding cells at one or more different scales; and
wherein the classification for each cell is further based at least in part on the feature extraction vector for each cell.

9. The method of claim 1, wherein determining, by the computing system, a classification for each cell based at least in part on the one or more cell statistics comprises:
accessing, by the computing system, a classification model that classifies cells of LIDAR data according to a predetermined set of objects of interest;
providing, by the computing system, the one or more cell statistics as input to the classification model; and
receiving, by the computing system, as an output of the classification model, an indication of whether that cell includes a detected object of interest.

10. The method of claim 9, wherein the classification model includes a decision tree classifier and wherein the output of the classification model provides a classification of each detected object of interest as a pedestrian, a vehicle, or a bicycle and a probability score associated with each classification.

11. An object detection system, comprising:
a LIDAR system configured to transmit ranging signals relative to an autonomous vehicle and to generate LIDAR data;
one or more processors;
a classification model, wherein the classification model has been trained to classify cells of LIDAR data; and
at least one tangible, non-transitory computer readable medium that stores instructions that, when executed by the one or more processors, cause the one or more processors to perform operations, the operations comprising:
determining one or more cell statistics characterizing the LIDAR data corresponding to each cell;
providing the one or more cell statistics as input to the classification model; and
receiving, as output of the classification model, a classification for each cell.

12. The object detection system of claim 11, wherein the classification model includes a decision tree classifier and wherein the operations further comprise receiving, as output of the classification model, a classification of each detected object of interest as a pedestrian, a vehicle, or a bicycle and a probability score associated with each classification.

13. The object detection system of claim 11, wherein the operations further comprise determining a feature extraction vector for each cell by aggregating the one or more cell statistics of surrounding cells at one or more different scales; and wherein the feature extraction vector is provided as input to the classification model.

14. The object detection system of claim 11, wherein the operations further comprise:
generating one or more proposed bounding shapes based at least in part on the indication of whether each cell includes a detected object of interest;
filtering the one or more proposed bounding shapes to determine a bounding shape corresponding to each instance of a detected object of interest; and
providing the one or more bounding shapes to an object classification and tracking application.

15. The object detection system of claim 14, wherein the classification model has been further trained to generate proposed bounding shapes for selected cells, and wherein generating one or more proposed bounding shapes comprises receiving, as output of the classification model, the one or more proposed bounding shapes.

16. The object detection system of claim 14, wherein generating one or more proposed bounding shapes comprises:
clustering cells having one or more predetermined classifications into one or more groups of cells, each group corresponding to an instance of a detected object of interest; and
generating a plurality of proposed bounding shapes positioned relative to each corresponding cluster of cells.

17. An autonomous vehicle, comprising:
a sensor system comprising at least one LIDAR system configured to transmit ranging signals relative to the autonomous vehicle and to generate LIDAR data; and
a vehicle computing system comprising:
one or more processors; and
at least one tangible, non-transitory computer readable medium that stores instructions that, when executed by the one or more processors, cause the one or more processors to perform operations, the operations comprising:
receiving LIDAR data from the sensor system;
generating a top-view representation of the LIDAR data that is discretized into a grid of multiple cells, each cell representing a column in three-dimensional space;
determining one or more cell statistics characterizing the LIDAR data corresponding to each cell;
determining a feature extraction vector for each cell by aggregating the one or more cell statistics of surrounding cells at one or more different scales; and
determining a classification for each cell based at least in part on the feature extraction vector for each cell.

18. The autonomous vehicle of claim 17, wherein the one or more cell statistics characterizing the LIDAR data comprise one or more parameters associated with a distribution of LIDAR data points projected onto each cell or one or more parameters associated with a power or intensity of LIDAR data points projected onto each cell.

19. The autonomous vehicle of claim 18, wherein the operations further comprise:
clustering cells having one or more predetermined classifications into one or more groups of cells, each group corresponding to an instance of a detected object of interest;
generating a bounding shape for each instance of a detected object of interest, each bounding shape positioned relative to a corresponding cluster of cells having one or more predetermined classifications; and
providing the bounding shape for each instance of a detected object of interest to an object classification and tracking application.

20. The autonomous vehicle of claim 19, wherein the operations further comprise controlling motion of the autonomous vehicle based at least in part on the bounding shapes for each instance of a detected object of interest provided to the object classification and tracking application.
